(19) United States
(12) Patent Application Publication
(10) Pub. No.: US 2003/0135582 A1
(43) Pub. Date: Jul. 17, 2003

(54) Context aware search service

(75) Inventors: Lee Allen, San Jose, CA (US); Toshio Miki, Cupertino, CA (US); Shahid Shoaib, San Jose, CA (US)

Correspondence Address: BRINKS HOFER GILSON & LIONE, P.O. Box 10395, Chicago, IL, 60610, US

(73) Assignee: DoCoMo Communications Laboratories USA, Inc.

(21) Appl. No.: 10/134,814

(22) Filed: Apr. 29, 2002

Related U.S. Application Data
(60) Provisional application No. 60/345,499, filed on Dec. 21, 2001.

(51) Int. Cl. G06F 15/16

(52) U.S. Cl. 709/217

(57) ABSTRACT

A context-aware search service is provided to users requesting information. The context-aware search incorporates contextual information such as the context of the user making the request, the external context of the user or terminal that the user accesses, or the characteristics or context of the terminal. The contextualized request is processed through sets of analyses to customize the request including analyses to determine an exact nature of the request, analyses to limit a universe of reference to be examined to provide the result, and analyses to select the most appropriate content and format for presentation to the user once the result is obtained from separate service providers.

### RELATED APPLICATIONS

This application is related to U.S. Provisional Patent Application serial No. 60/345,499 filed Dec. 21, 2001 in the names of Lee Allen, Toshio Miki, and Shahid Shoaib and entitled “Context Aware Search Service,” which is incorporated herein by reference in its entirety.

### BACKGROUND

This application relates to a context-aware search service. More specifically, this application relates to a context-aware search service in which a user enters a query, the query is customized with contextual information including the real-time condition and situation of the user, and a result to the customized query is relayed to the user in a customized manner.

Mobile wireless customers have traditionally been connected to only one network operator, with both basic services such as voice communications and enhanced services such as Internet access provided by that network operator. In the near future, however, it is likely that mobile virtual network operators (MVNO) will make a wider variety of services available to their customers. The virtual operator is a term used in the art to describe a carrier that may or may not own their own infrastructure. The services that the virtual operator offers are likely to be provided by many different third parties, including many different infrastructure operators in a heterogeneous access environment. This heterogeneous access environment includes the different operators as well as multiple users of different types of devices, each of which perhaps uses a different communication format. It is likely that the customer will contract with one overall service provider, the virtual operator, and will expect all dealings to be with that provider, regardless of how many operators are involved in the provision of services.

Some present virtual operators provide Internet-based search services that may incorporate personal information about the user such as age, job, and marital status. In addition, other information regarding preferences of the user, frequently visited Internet sites or recent purchases on various sites for example, may be incorporated into a search. Despite these additions, improvements in searches, both on the Internet and otherwise, are welcome to decrease the amount of work involved in accumulating and sorting replies to the query from the search mechanisms as well as to decrease the amount of information received that the user must examine.

Further, conventional searches for people performed by search engines are usually extremely general, as search engine providers strive for both consistency and thoroughness. However, this is typically not the same situation for people that are in a mobile yet connected environment. With the ever-increasing amount of information available when performing a search, it would be especially beneficial for the users of mobile communication equipment (mobile customers) for the system to further streamline both the parameters and responses of the search. Besides the above reasons, mobile customers typically have a need for relevant and targeted information for whatever search they require, both because time is important (they are moving) as is the cost (perhaps both for time and every packet being transmitted).

### BRIEF SUMMARY

To achieve the above objectives, efficient, relevant services are performed in which the user's request (or query) is augmented by incorporation of contextual information regarding the user or the terminal accessed to request the services and the responses produced by one or more different service providers that employ the augmented queries are further altered before transmitting an overall result to the user.

In a first embodiment, a context-aware search service comprises a virtual network operator, a terminal in communication with the virtual network operator, and at least one service provider in communication with the virtual network operator. The virtual network operator customizes requests from the terminal as a function of one or more of an external context of the terminal, context of usage of the terminal and a user operating the terminal. The virtual network operator selectively forwards the customized requests to the service provider and provides a result based on the response returned by the service provider to the terminal.

The virtual network operator may be in communication with one or more external context providers that provide the external context of the terminal and/or the context of usage of the terminal. The external context provider may provide an identity of the user, a physical location of the user, a method of locomotion of the user, a time of the request from the terminal and/or a date of the request from the terminal.

The virtual network operator may provide information regarding user preferences and may comprise at least one analysis to customize the requests from the terminal prior to submission to the service provider. The analyses may determine an exact nature of the request from the user and limit a universe of reference that the service provider examines to provide responses and may select the most appropriate content and format for presentation of the result to the user.

The service provider may be an Internet provider, a specialized data provider, or a specialized service provider and may assess a transaction fee to the virtual network operator for each request provided by the virtual network operator to the service provider or to the user.

The results may include analysis of a purchase history of the user and recommendations transmitted to the terminal regarding potential vendors. The purchase history of the user and recommend potential vendors to the user based on the request may be analyzed. The customization information included in the customized requests may be aggregated with the customization information from other users of other terminals and a business proposal created and supplied to subscribing vendors on behalf of the user and the other users. Specially formatted requests may be organized, verified, filtered and enhanced and special results provided to the specially formatted requests. The user may have control over whether user preferences are supplied to the service provider. The customization may include a real-time condition or a real-time situation in which the user is situated.

In a second embodiment the context aware search services system comprises an apparatus that accepts a query from a user, customizes the query by including at least customer-identifying information of the user and context information that contains at least one of an external context of the apparatus and a context of usage of the apparatus, and returns a result based on the customized query to the user.

The apparatus may further comprise at least three distinct entities, one of which furnishes the customer-identifying information of the user, one of which furnishes the context information, and one of which searches a data base based on the customized query and returns a reply based on the search.

The apparatus may comprise at least three sets of analyses to customize the requests, a first analysis to determine an exact nature of the query from the user, a second analysis to limit a universe of reference to be examined to provide the result, and a third analysis to select the most appropriate content and format for presentation to the user.

The result may include analysis of a purchase history of the user and recommendations may then be transmitted to the user regarding potential vendors. The customization information included in the customized requests may be aggregated with customization information from other users and a business proposal created and supplied to subscribing vendors on behalf of the user and the other users. Specially formatted requests may be organized, verified, filtered and enhanced and special results provided to the specially formatted requests. The customization may include a real-time condition or a real-time situation in which the user is situated.

A third embodiment is method of customizing a request of a user to a system. The method comprises augmenting the request with at least context information that contains at least one of an external context of the user making the request, an external context of one of the user and terminal used to make the request, and characteristics of the terminal used to make the request, searching at least one database with information dependent on the augmented request, and returning a result to the user based on responses of the search.

The method may further comprise further augmenting the request with customer-identifying information of the user prior to searching the database.

The method may further comprise applying a plurality of sets of analyses to customize the augmented request prior to searching the database and applying at least one analysis to the responses of the search prior to returning the result to the user.

The method may further comprise determining an exact nature of the request from the user and limiting a universe of the database to be searched prior to searching the database and forming the result by selecting a most appropriate content and format for presentation of the responses prior to returning the result to the user.

The method may further comprise including analysis of a purchase history of the user in the responses and transmitting recommendations to the user regarding potential vendors.

The method may further comprise aggregating the customization information of the user with customization information from other users, creating a business proposal, and supplying the business proposal to subscribing vendors on behalf of the user and the other users.

The method may further comprise organizing, verifying, filtering and enhancing requests to form specially formatted requests and providing special results to the specially formatted requests.

The method may further comprise including a real-time condition or a real-time situation in which the user is situated in the context information.

The method may further comprise permitting the user to have control over whether at least some customer-identifying information is supplied to entities that perform the search.

These objectives are merely representative of objectives for the present invention: other objectives may become apparent from the description below.

### DESCRIPTION OF DRAWINGS

FIG. 1 shows a first step in a first embodiment;

FIG. 2 shows a second step in the first embodiment;

FIG. 3 shows a third step in the first embodiment;

FIG. 4 shows a fourth step in the first embodiment;

FIG. 5 shows a fifth step in the first embodiment;

FIG. 6 shows a sixth step in the first embodiment;

FIG. 7 shows a seventh step in the first embodiment;

FIG. 8 is a flowchart illustrating the above steps;

FIG. 9 shows the message flows between the various entities as the personalization is performed in one embodiment;

FIG. 10 shows revenue flow according to the first embodiment;

FIG. 11 illustrates a first embodiment of a virtual operator;

FIG. 12 illustrates a first embodiment of a Service Provider; and

FIG. 13 illustrates a first embodiment of a mobile device or terminal.

### DETAILED DESCRIPTION OF EMBODIMENTS

Existing personalization systems only personalize the responses to the user but do not personalize the request from the user. Thus, an opportunity exists for the mobile virtual network operator (virtual operator) to provide context-aware services. One of the possible services includes a context-aware search that incorporates contextual information, such as the spatial location of the customer or terminal that the customer uses to request the search, into the request from the customer. By increasing the amount of information associated with the original query transmitted to various sub-suppliers of information (i.e. other service providers), the service providers are better able to limit the search and provide relevant information in responses. The virtual operator can further sort and present this information to the terminal and ultimately the customer in a timely and more relevant manner. The overall result to the user will, for example, require less computational power due to the additional focus of the search parameters provided by the context information and decrease in hits that must be sorted by the virtual operator. This in turn will decrease the user cost by decreasing the number of packets traversing the wireless network (each of which the user pays for) when prioritizing the content/service offerings. This use of the combination of context information with other available information will be called customization or personalization. Thus, customization will increase user convenience by reducing cumbersome interactions with a mobile device both when supplying an input as well as while browsing for services or content. In addition, personalization will increase the consistency of service offerings across a wide heterogeneous environment, that is, the different services will ultimately all be available to mobile users who use diverse carriers.

The context-aware search services is in general provided to customers operating wireless devices, such as cellular telephones, personal digital assistants (PDAs), visors, portable (laptop) computers of under about 12 pounds, on-board vehicle computers/displays (including vehicles that are motorized or not) or any other wireless terminal. However, the context-aware search services may additionally be provided to customers operating wireline based devices such as personal computers, network access terminals, or any other type of wireline terminal.

The customer may be mobile, e.g. traveling at the time of the request and response, or at a stationary terminal that the customer has accessed, e.g. a hotel room. When the user is in the former environment, that is a mobile environment, customization may be more important. Reasons behind this include that mobile devices, such as PDAs, have limited input capabilities which means that it is inconvenient and cumbersome for the user to either supply a significant amount of information to the mobile device or otherwise interact considerably with the mobile device. Furthermore, when using different service providers, the user has to provide personal information separately to each service provider. Not only is this potentially cumbersome, but in addition, the privacy of personal information may not be guaranteed. In addition, mobile devices have limited output capabilities, such as display size. This leads to additional burdensome problems as the user has to browse through many different screens before finding the content or service sought. Although these problems may or may not be relatively limited at present, with the continuing growth and complexity of internet sites and other available services, the problems associated with mobile devices will only continue to grow in the future.

Note that the customer of the virtual operator service is assumed to be the user of the terminal to which the request (or query) is entered. Thus, the terms customer and user are herein used interchangeably. Of course, a customer may loan his or her (say) cellular telephone or laptop computer to another person for use, but for the purposes of the embodiments below, the person using the terminal is defined as the customer. Alternatively, of course, the terminal or virtual operator may request an access code for allowing identification of the user when making a request, regardless of the actual owner of the device. The terminal includes any electronic device, such as a wireless phone or computer, or mechanical device that is coupled and associated with an electronic device, such as a wireless keyboard or touchpad. The terminal, as used herein, is capable of communicating with the remote service provider, either directly or through an intermediary.

In one embodiment, a context-aware search service is a search service operation controlled at least in part by:

1) The context of the user making the request (for example, user identity, activity, location, schedule, usage habits);

2) The external context of the user or terminal that the user accesses (for example, time of day, nearby people, other nearby activity); or

3) The characteristics or context of the terminal (for example, computing capabilities, display capabilities, proximity to other devices with resources available for sharing).

For example, if the request was the search phrase “Shakespeare”, a search on a desktop computer would return a prioritized listing of Internet sites which sell Shakespeare books, Internet sites that have his works or links to his works, and other information as appropriate to that environment and as further pre-specified by the user. The same search while on a mobile computer would return, for example, a prioritized listing of nearby shops or libraries where Shakespeare books could be found, along with directions. If performed on a mobile terminal while in a library, the same search might yield, for example, a listing of Shakespeare works available at that library, along with instructions on how to find the works in that library.

In one embodiment, a number of entities may be used to provide a context-aware search service to the customer. Some possible entities are tabulated in Table 1. As shown in Table 1, the first such entity is the virtual operator. Once the customer enters a request, the virtual operator acts as a proxy on the behalf of customer for at least that request. As the proxy of the customer, the virtual operator communicates with other entities that may be necessary for fulfilling the request prior to sending the ultimate result back to the customer. The virtual operator is also responsible for accounting, authentication, and controls access to the user contextual information, which maybe distributed across multiple databases.

These other entities may include various service providers. One such service provider that may be used is a Context Information Provider (CIP). The CIP provides context information such as real-time information, database information and/or any other kind of video, audio or text information and data. Another type of service provider that may be used is a Specialized Data Provider (SDP), which supplies specialized data, such as ISBN or GPS data. In addition, a Specialized Search Service Provider (SSSP) may be used to supply specialized and/or optimized search capability through a high-quality search engine or using high-quality data (and may further use one or more SDP for specific searches). Although not shown in Table 1, the context-aware service may require access to a service provider that supplies a general body of information such as an Internet Service Provider (ISP) with access to the Internet. The specialized providers may be, for example, a regional or local provider of up-to-date, accurate information in the location in which the customer is located—e.g. a provider that supplies information of one quality free to the Internet and information of another, higher quality to anyone who pays a subscription fee.

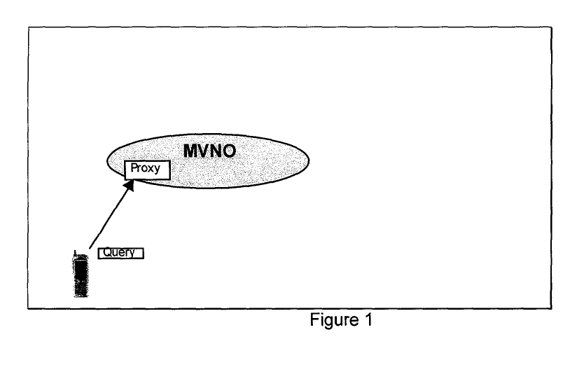

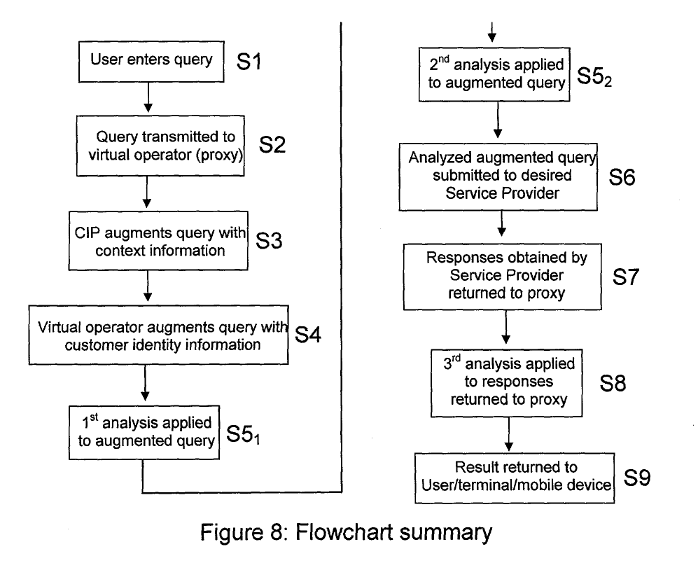

Turning to the mechanics of the customer making a request and receiving an ultimate result to his/her request, FIGS. 1-7 illustrate one embodiment of a request-to-result cycle. FIG. 8 provides a flowchart summarizing FIGS. 1-7.

S1 (FIG. 8): User Enters Query

FIG. 1 depicts a user entering a request on a terminal (here a cellular telephone). As shown, the terminal can be located anywhere that it can communicate with the virtual operator, either directly or through an intermediary, such as a base station or booster station. Once the user enters a request and the request has been received by the virtual operator (S2 in FIG. 8), the terminal that is used to enter the request hands off control to the virtual operator. The virtual operator then acts as a proxy on the behalf of customer for at least that request. Control may be handed off at any point after the request is completed, preferably immediately after completion of transmission of the request from the terminal to the virtual operator.

S3 (FIG. 8): CIP Augments Query

Now that the virtual operator maintains the request and is the terminal proxy, additional information is added to the query to indicate the context of the customer or terminal. As above, this addition information includes context information regarding at least one of the customer him or herself, the environs (spatial and temporal) of the user or the specific terminal from which the user is accessing the virtual operator, and the particular characteristics of the terminal. Some or all of the information transferred between the virtual operator and the CIP may be transferred either using conventional data transfer practices or using a special procedures distinctive to the CIP.

The information about the user may include, for example, the identity of the user, the activity in which the user is engaging, or the locomotive means of the user (e.g. is the user traveling by foot or via automobile).

The environs of the user or terminal may include, for example, the date/time of year, time of day, or nearby people or activities. The time may be, for instance, the time of the request from the terminal to the virtual operator or of communication between the virtual operator and the Context Information Provider (which, hopefully will be about the same). The terms nearby and local encompass the general vicinity of the user, from immediately adjacent to the user/terminal to a few miles distant from the user/terminal, and the absolute distance may be dependent on the request itself. The environs of the user/terminal, however, may not be limited to nearby people, places, or things, and may include farther away people, places or things, such as points of reference such as other cities or even star positions.

The characteristics of the terminal may include, for example, computing capabilities (e.g. processor type and speed, available memory, resources available for sharing), display capabilities (e.g. screen type and size, maximum screen resolution), communication protocols between the terminal and the virtual operator, or proximity to other devices with resources available for sharing and with which the terminal can communicate.

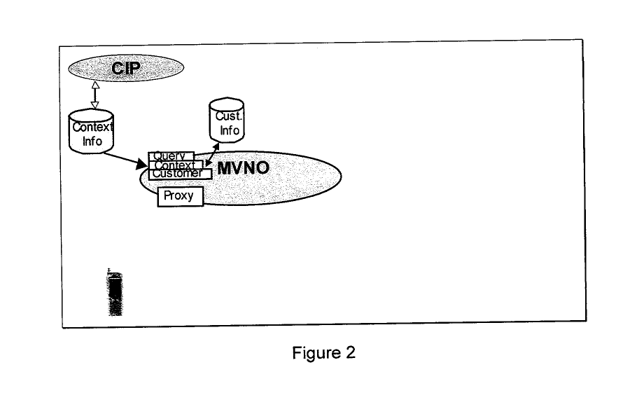

As shown in FIG. 2, at least a portion of the context information is provided to the virtual operator from the Context Information Provider. Information flows between the virtual operator and Context Information Provider via one or more context gateways that are capable of passing information between the two. In one embodiment, the virtual operator solicits context information from the Context Information Provider and the Context Information Provider supplies that information.

The virtual operator may communicate with the Context Information Provider in a number of ways. In one embodiment, after receiving a request from the terminal, the virtual operator may first solicit context information from the Context Information Provider, which then supplies the virtual operator with the context information. Alternatively, the Context Information Provider may automatically supply the context information to the virtual operator upon the virtual operator receiving a request from the terminal. The context information supplied by the Context Information Provider may be consistent, that is independent of the solicitation by the virtual operator, or may be specific to the particular solicitation by the virtual operator. This is to say that in the alternative embodiment, the virtual operator may solicit only the time from the Context Information Provider for one request and may solicit both the time and date from the Context Information Provider for the next request.

As shown in FIG. 2 (S4 in FIG. 8), contextual information is supplied externally by a separate external provider and other information is supplied internally by the virtual operator. For example, customer profiles, accumulated and maintained by the virtual operator, may be used to add further customer-identifying information or customer history, such as preferences, schedule (e.g. daily planner information) and buying history to the context information already supplied by the Context Information Provider. The virtual operator may update the user information after each request or after a specific event, such as after a set period of time. The virtual operator may also have set classes into which the customer has been placed. Thus, whenever a request is sent from the terminal to the virtual operator and the virtual operator identifies the customer, a particular set of characteristics associated with the class of which the customer is a member is appended to the request. Note that prior to this, the user may have specified different privacy settings for the CIP, virtual operator, various service providers, networks, devices, or locations (or any other factor) and thereby limit the personal information used to customize the request.

In another embodiment, not shown in FIG. 2, the context information may be supplied by the virtual operator without the need to solicit information from an external provider. Alternatively, some combination of the above may exist—that is both the virtual operator and the Context Information Provider may supply a portion of the context information. Any internal or external memory necessary to store particular context information may be present in either or both of the virtual operator and the Context Information Provider.

In another embodiment not shown in FIG. 2, multiple Context Information Providers may exist, each Context Information Provider providing unique or substantially unique information to the virtual operator through the context gateways. Of course, this is not to say that overlapping information between different Context Information Providers (such as customer identification or preferences) will not exist in an alternate embodiment, only that any overlapping data will most likely be minimized. In one example, one Context Information Provider may supply customer preferences while another may supply the time and date.

S5_{1,2} (FIG. 8): Limiting the Query

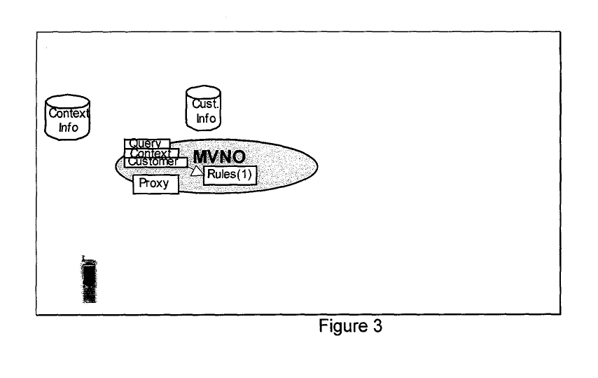

Once the virtual operator has the appropriate context and customer-identifying (customer) information, the augmented request containing the original request as well as the context and customer information is processed through a first analysis to determine the exact nature of the inquiry (i.e. determine what is the question). This process is illustrated in FIG. 3. In one example, if the user requests information about Shakespeare, the exact nature of the inquiry may be an Internet request about the author Shakespeare (such as history, works, quotations), an inquiry about the location of local bookstores that carry the works of Shakespeare or works about Shakespeare, or location of the works of Shakespeare or works about Shakespeare in the local library. As above, any combination of context and customer information may be included and may be dependent on the actual request from the user. The decision of whether or not to include context information in the search may rely upon the virtual operator, although in general some form of context information will exist.

As shown in FIG. 3, the first analysis are stored and applied by the virtual operator. In an alternative embodiment, once the augmented request is formed, the virtual operator may supply the augmented request to an external entity which has stored the first analysis. This external entity would then apply the first analysis to the augmented request and return the augmented request subject to the first analysis to the virtual operator for subsequent processing and communication.

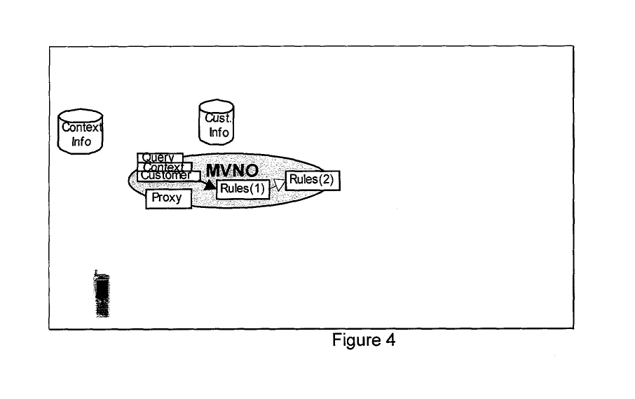

In either embodiment, as illustrated in FIG. 4, after the augmented request is processed through the first analysis, the augmented request subject to the first analysis is next processed through a second analysis. The second analysis determines the most appropriate sites for inclusion in the search universe (i.e. who are we going to ask to get the answer to the query). Thus, if the exact nature of the query was determined to be, for instance, where to purchase specific works of Shakespeare or works about Shakespeare, the search universe might include the location of local bookstores that carry the works of Shakespeare or works about Shakespeare as well as various prices of the works. A personalized query is thus formed after the augmented request is processed through the first and second analysis (hereinafter referred to as the analyzed augmented query). Appropriate data providers that may have the information sought are selected accordingly.

Similar to the above, an external entity may be used to store and apply the second analysis and return the augmented request subject to the second analysis to the virtual operator for subsequent processing and communication. This external entity may be the same or different from the entity that stored and applied the first analysis. If it is the same as the external entity used to store and apply the first analysis, the augmented query subject to the first analysis does not have to be sent to the virtual operator before processing by the second analysis occurs. In other words, the virtual operator merely sends out the augmented query to the external entity and receives a analyzed augmented query rather than an intermediate reply.

S6 (FIG. 8): Query Transmitted to Service Provider

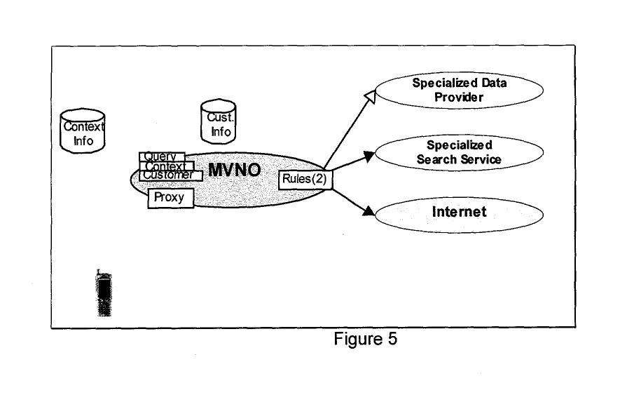

In any embodiment, the analyzed augmented query is next sent to the Internet or other information resource for responses. If there are any Specialized Search Service Providers or Specialized Data Providers to be included in the search, queries are constructed and sent to those entities also, as selected by the virtual operator. This process is shown in FIG. 5. Although FIG. 5 depicts the analyzed augmented query as being transmitted to all of the service providers, the virtual operator may select a subset of the set of available service providers from which to request a response and transmit the analyzed augmented query to only those service providers contained in the subset. As above, information is transferred between the virtual operator and the service provider either using conventional data transfer practices or using a special procedures distinctive to the particular service provider.

Each Specialized Search Service Provider and Specialized Data Provider may require its own format for communication with the virtual operator. The virtual operator, in turn, should have any of the necessary formats stored or readily available for use when necessary. After formatting the analyzed augmented query as necessary for the particular service provider, the virtual operator then sends the formatted analyzed augmented query (hereinafter referred to as formatted augmented query) to the particular service provider. Examples of the different service providers may include a Specialized Data Provider that provides specialized information such as ISBN or GPS information and a Specialized Search Service Provider that provides specialized and/or optimized search capability through a high-quality search engine or using high-quality data.

Although not shown in FIG. 5, if a query requires responses from more than one search provider, say an Internet provider and a Specialized Data Provider, the communication timing between the virtual operator to the search providers may be varied dependent on the service providers. In one example, the virtual operator may transmit each formatted augmented query to both service providers simultaneously. However, if one service provider is known to take a longer time than another service provider to supply responses and the virtual operator only communicates with one service provider at a time, the virtual operator may transmit an appropriately formatted augmented query to the slower service provider first and then transmit an appropriately formatted augmented query to the faster service provider. One advantage of this method is the increase in speed of the result to the customer.

In one example, say it takes 5 seconds to format and transmit each query, 10 seconds to receive responses and two service providers are used. The faster of these service providers takes 30 seconds to return responses and the slower takes 60 seconds to return responses. In this case, it will take (5 [transmission to the faster service provider]+5 [transmission to the slower service provider]+60 [receive responses from the slower service provider]+10 [transmit responses from the slower service provider]=80) seconds for the virtual operator to receive both responses if the query is transmitted to the faster service provider first. This is because the responses from the faster service provider have already been obtained by the virtual operator while the slower service provider is still operating. However, it will only take (5 [transmission to the slower service provider]+60 [receive responses from the slower service provider]+10 [transmit responses from the slower service provider]=75) seconds for the virtual operator to receive both responses if the query is transmitted to the slower service provider first as transmission to and responses from the faster service provider can be achieved by the virtual operator while the slower service provider is still operating. As the format and transmission time increases, the time saved also increases, as at least a portion of the time to format and transmit to the faster service provider may be saved. Note however that if the virtual operator has the capability to communicate with all the desired service providers at the same time, transmitting formatted augmented queries at different times may not be necessary.

S7 (FIG. 8): Response Returned to Virtual Operator

Once the formatted augmented query has been transmitted to one or more service providers, the various service providers perform searches and transmit responses to the virtual operator.

S8 (FIG. 8): Virtual Operator Reanalyzes Information

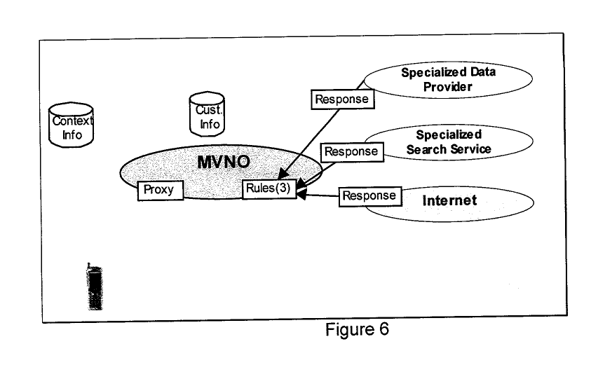

After the virtual operator receives these responses, as shown in FIG. 6, the responses from the Internet searches, Specialized Data Provider and Specialized Search Service Provider are processed though a third analysis to form analyzed responses. As the responses from the different service providers may be received by the virtual operator at different times, the responses may be processed through the third analysis at the same time or at different times. As above, one advantage of such a method is that time may be saved by processing the responses at staggered times, however, the responses may not be complete if this method is used. If the responses are received at different times but all of the responses are to be processed through the third analysis at the same time, the virtual operator may store all information received before the last set of received information.

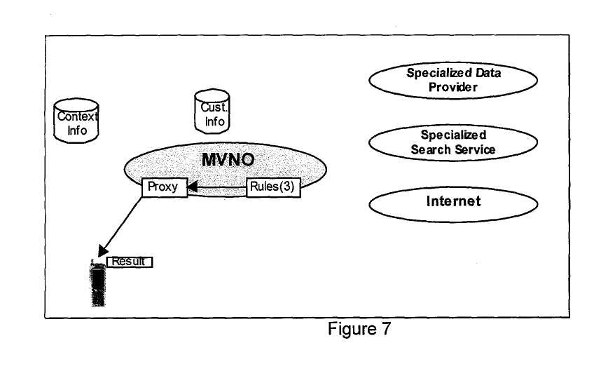

The third analysis is used to determine the most appropriate format and content for presentation to the customer. For example, the most appropriate format may be a visual (say textual or graphical) display or an auditory presentation. The third analysis determine whether, for example, a high resolution image is to be displayed for a laptop computer, which is the terminal, in one case or textual information is to be presented on the LCD screen of a cellular phone. If the most appropriate format is selected auditory the content may include, for instance, verbal instructions on the quickest way to get to a particular location or selections from a specific musical piece. As with the first and second analysis, although the third analysis is shown in FIG. 6 as being performed by the virtual operator, the virtual operator may alternatively communicate with an external entity to process the responses through the third analysis. After the results are processed through the third analysis, the virtual operator formats and transmits the analyzed responses as a result to the terminal, as shown in FIG. 7. The customer is then presented with the result (S9 in FIG. 8).

In the above embodiment, the services provided by the service providers are delivered to the user through the user personal proxy. Alternatively, these services may be provided directly to the terminal depending on service specific criteria.

Of course, some information such as the customer identity may be internally available to the virtual operator from the request transmitted from the customer without need to reference a Context Information Provider. Other context information may be transmitted with the request (or immediately/soon after the request) and may be periodically updated by the terminal. If this context information is not transmitted with the actual request (or when being periodically updated), it may be transmitted automatically by the terminal or the virtual operator may request the information, which the terminal then supplies once the terminal receives the request. If this information is transmitted automatically, it may further be transmitted upon the occurrence of a specific event, such as at specific times, when the customer reaches a certain distance away from the location of the last transmission, or when the customer pulse rate reaches a target value or changes by a particular amount.

The periodically updated information may be used to change the parameters associated with the analyses for application to the request or from the responses returned by the service providers. Similarly, the periodically updated information may be provided to the service providers immediately before or concurrent with the search to alter the responses transmitted to the virtual operator. Such periodically updated information includes at least any real-time information necessary for the search. Examples of real-time information include the physical location of the customer or the medical condition of the customer (e.g. heart rate, blood pressure, body temperature, insulin level), which can of course be transmitted by the terminal or by other, separate electronic equipment used to obtain (and perhaps transmit) the information.

The virtual operator may also include additional functionality and/or sets of analyses such as, for example, alerting capabilities in result to conditions setup by the customer (e.g. when a certain Shakespeare book has been returned to the library) and customization capability of the virtual operator by the customer. Other additional functionality may include variable levels of services selectable by the customer such as, for example, economy services with lower levels of access to the Context Information Provider, Specialized Data Provider, Specialized Search Service Provider, intermediate services with access levels configured by the customer and premium services with full access to the Context Information Provider, Specialized Data Provider and Specialized Search Service Provider.

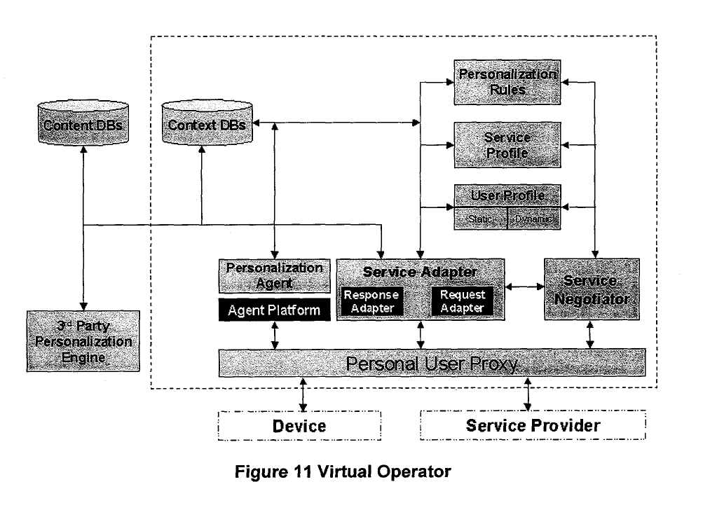

The structure of one embodiment of the virtual operator is shown in FIG. 11. The virtual operator contains a personal user proxy module and a main personalization module, which may reside anywhere in the virtual operator. As above, the modules personalize a number of different things including: the services provided by the virtual operator itself, the user requests before they reach the Service Provider, the responses from the Service Provider before they reach the user, the service or content by the virtual operator (or the Service Provider itself by allowing the service provider to send a personalization agent to the personal user proxy, which is useful when personalization can only be performed by the Service Provider but the user is not willing to disclose contextual information directly to the service provider), and negotiation of privacy and context usage with the Service Provider as well as the user him or herself.

As illustrated in this embodiment, the virtual operator contains the personal user proxy module (Personal User Proxy) that communicates with external elements including both the user and the Service Provider. The Personal User Proxy also communicates with internal elements of the virtual operator, which include a Personalization Agent as well as Agent Platform, a Service Adapter, and a Service Negotiator. The Personal User Proxy acts as a proxy on behalf of the end user and works with the Service Provider and the Service Adapter towards the personalization of services requested by the user.

The Service Adapter has two components: the Request Adapter, which performs request personalization of incoming requests from the mobile device or terminal, and the Response Adapter, which personalizes incoming content from the Service Provider and adapts services provided by the virtual operator for the user device/terminal. The Service Negotiator is responsible for negotiating service personalization and user privacy settings with the remote entity using a service negotiator protocol. The Service Negotiator in the virtual operator may either represent the user him or herself in service negotiations with other Service Providers or negotiate with the user services provided by the virtual operator itself. The service negotiator protocol allows entities to negotiate service personalization and privacy settings before and during a service provision (the Service Provider may tell the remote entity about each service it provides, how and what it personalizes in that service, a prioritized listing of context data it needs to do the personalization and privacy policy etc. The user may in turn tell the Service Provider about its privacy requirements and what services it wants to be personalized and what context data would be made available to the Service Provider).

The Agent Platform allows mobile personalization agents from Service Providers to perform personalization of services at the Personal User Proxy. The Agent Platform may use a firewall to stop Service Provider-provided agents from transmitting sensitive user information to other entities. The Agent Platform communicates with a Personalization Agent. The Personalization Agent is sent by the Service Provider to the Personal User Proxy to perform service specific personalization when either personalization is not possible/feasible at the service provider end or user privacy requirements dictate that personalization be done by the Personal User Proxy only.

The Personalization Agent, Service Adapter, and Service Negotiator, as well as one or more internal databases of context information (Context DBs), all communicate with a User Profile, Service Profile, and Personalization Rules (analysis). The Context DBs are owned by the virtual operator and, as above, may include user preferences, user location information and user activity.

The User Profile contains virtual operator specific user information which is retained in a Dynamic Profile and Static Profile. The Dynamic Profile contains service specific information about the current session, for example, clickstream data. The Static Profile contains, for example, user registration information and static service preferences. The Service Profile contains information about specific services provided by the virtual operator, e.g. service attributes and how they can be personalized. The Personalization Rules contains a means for analysis of data supplied to an input and is specified by the virtual operator. As above, this analysis defines how content and services will be personalized for either specific users or different classes of users.

The Service Adaptor and Context DB may communicate with external elements, including one or more content databases (Content DBs) and/or a Third Party Personalization Engine. The Content DBs store the content that is to be personalized, for example web pages (dynamic or static) and media streams. The virtual operator may use a Third Party Personalization Engine in addition to the internal system described above and establish a collaborative filtering system that provides recommendations based on data from the Service Adapter on personalization of the user request and/or responses from the Service Provider.

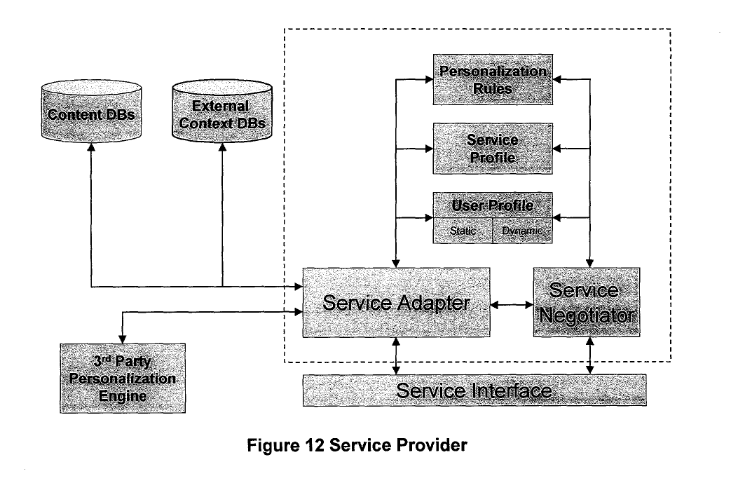

One embodiment of the Service Provider is shown in FIG. 12. In this embodiment, the Service Provider is responsible for personalization of services at the service provider's end. It supports different types of personalization e.g. user driven, inference based and collaborative filtering with the virtual operator. It also allows the Service Provider to negotiate with the user regarding, for example, privacy settings as well as the type of contextual information required for personalization.

The Service Provider has a Service Interface that controls communication between the Service Provider and the virtual operator or other system. Similar to the virtual operator, the Service Provider contains a Service Adapter, Service Negotiator, User Profile, Service Profile, and Personalization Rules. The communication stream between the internal elements of the Service Provider is much the same as that of the virtual operator.

The Service Interface communicates with the Service Adapter and Service Negotiator. The Service Interface receives requests for service and service negotiation and subsequently passes the incoming service requests to the Service Adapter and the incoming service negotiation messages to the Service Negotiator. The Service Interface is also responsible for delivering service to the user directly or to the virtual operator.

The Service Adapter is a core module that is responsible for personalizing the service for individual users. The Service Adapter receives service requests from the Service Interface and sends back adapted personalized content to the Service Interface. The Service Adapter also communicates with the User Profile, Service Profile, Personalization Rules, Context & Content Database(s) and external personalization engines through standard interfaces in much the same manner as the virtual operator. In addition, the Service Adapter may personalize the service of the Service Provider based on different methods. For example, these methods may include collaborative filtering/inference based using external personalization engines or by using user driven/user requested personalization based on information from various contextual data sources. The Service Adapter may also support rule based personalization.

The Service Negotiator, User Profile and Personalization Rules are all similar to those of the virtual operator. This is to say that the Service Negotiator is responsible for negotiating service personalization and user privacy settings with the remote entity using the Service Negotiation Protocol. The User Profile contains Service Provider specific user information (i.e. a Dynamic Profile that contains service specific information about the current session and a Static Profile that contains user registration information and static service preferences). The Service Profile contains information about specific services provided by the service provider including service attributes and how they can be personalized. The Personalization Rules contains personalization rules or analysis specified by the Service Provider that define how content and services will be personalized for different classes of (or specific) users.

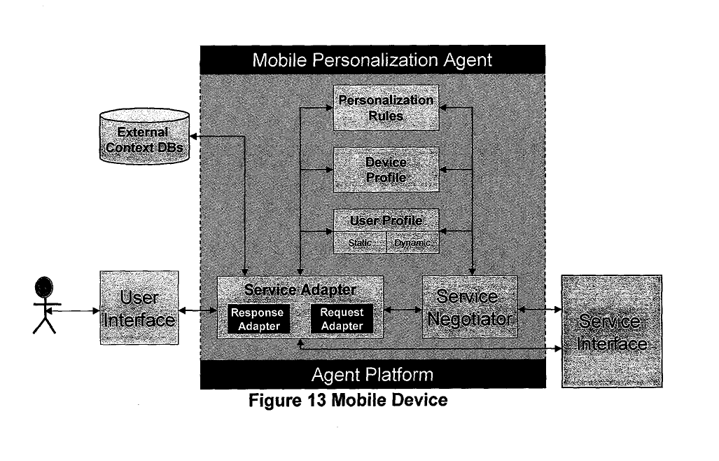

One embodiment of the Mobile Device (or terminal) is shown in FIG. 13. The device includes a Mobile Personalization Agent (MPA) and an Agent Platform. The mobile device will need to support the Agent Platform. The Mobile Personalization Agent for a specific user will download onto the device once the user has been authenticated.

The device contains a Service Interface that connects the device with various network entities such as the virtual operator and Service Provider as well as exchanging service negotiation messages with the Service Providers and the virtual operator. The MPA contains a Service Adapter that has a Request Adapter, which performs request personalization of incoming requests from the user received through the user interface, and a Response Adapter, which adapts services provided by the virtual operator for the end user device and also personalizes incoming content from Service Providers. This is similar to the Service Adapter in the virtual operator above. In addition, the MPA contains a Service Negotiator, which is responsible for negotiating service personalization and user privacy settings with the service providers and/or the virtual operator using the Service Negotiation Protocol, as above.

The Service Adapter and Service Negotiator communicate with a User Profile, Device Profile, and Personalization Rules. The Service Adapter communicates with the user through a user interface and also may communicate with a Context database much the same as above. The User Profile contains device specific user profile information. This profile information consists of a Dynamic Profile, which contains service specific information about the current session, and a Static Profile, which contains user registration information and static service preferences. The Device Profile contains information about the device including input, display and processing capabilities, similar to the Service Profile provided in the Service Provider or virtual operator. The Personalization Rules as above contains personalization rules or analysis specified by the user, which can be used for request and/or response personalization.

The architecture described above has three main components (device, virtual operator, and service provider) that may work in conjunction with each other in any combination towards the personalization of services. Thus, seven different operational modes may exist: each component personalizing the request/response by itself, pairs of components working in combination, or all three components working in combination.

In the Device Mode, all the personalization is done at the device itself. This mode will be useful in the following scenarios: the service provider is unable to provide personalization, the virtual operator is unable to provide personalization, application security or user privacy requirements dictate that personalization be done on mobile device only, or the mobile device has sufficient user profile information and processing power to do the personalization itself. In this mode there will be no service negotiation between the mobile device and the virtual operator or the service provider. The personalization will only be response personalization. The device may, however, allow the virtual operator or the service provider to send service specific personalization agents in order to perform the required personalization.

In the Virtual Operator Mode, the virtual operator provides all the personalization. This mode will be useful in the following scenarios: the service provider is unable to provide personalization for that particular service, user privacy settings dictate that personalization must be done at the personal user proxy, the mobile device is unable to provide personalization for that particular service, or the virtual operator provides the services. This mode will most often be used by the personal user proxy to modify content or services to meet the capabilities/needs of the device. It will also be used when the service provider needs to send a mobile agent to the personal user proxy to perform the service specific personalization.

In the Service Provider Mode, the service provider provides all the personalization. This mode will be used in almost all scenarios in which the service provider wishes to personalize services or content.

In the Device-Virtual Operator Mode, the responsibility for personalization is distributed between the mobile device and the virtual operator. This mode will be used in scenarios where the service provider is unable to provide personalization or due to application specific user security and/or privacy requirements. The device can use both request and response personalization while the virtual operator can only use response personalization in this mode. The parameters for personalization and privacy will be negotiated between the device and the virtual operator.

In the Device-Service Provider Mode, the responsibility for personalization is distributed between the device and the service provider. This mode will be used in scenarios where the virtual operator is unable to provide personalization, is not required for personalization or due to application specific user security and/or privacy requirements. The device can use both request and response personalization while the service provider can only use response personalization in this mode. The parameters for personalization and privacy will be negotiated between the device and the service provider.

In the Virtual Operator-Service Provider Mode, the responsibility for personalization is distributed between the virtual operator and the service provider. This mode will be used in scenarios where the device is unable to provide personalization due to lack of processing power or any other factor or is not required for personalization. The virtual operator can use both request and response personalization while the service provider can only use response personalization in this mode. The parameters for personalization and privacy will be negotiated between the virtual operator and the service provider.

In the Device-Virtual Operator-Service Provider Mode, personalization is carried out at all three places i.e. the service provider, the virtual operator and the end device. This mode will be used in scenarios where each one of the three components can provide some personalization that the other cannot or when load balancing of processing associated with personalization is desired. The device and the virtual operator can use both request and response personalization while the service provider can only use response personalization in this mode. The parameters for personalization and privacy will be negotiated between the device and the service provider, but the personal user proxy may change these parameters according to the situation.

In summary, examples of information that may be used in the contextualization and augmentation of the query or result eventually returned to the customer include the user's identity, spatial information (such as location, orientation, speed, acceleration), temporal information (such as time of the day, date, season of the year), environmental information (such as temperature, humidity, light/noise level), the user's physiological measurements (such as blood pressure, heart rate, muscle activity), the user's activity (such as talking, reading, walking, running), the user's social situation (such as who the user is actively with, people who are physically nearby), the user's personal preferences and capabilities, the user's schedules and agendas, resources that are nearby (such as accessible devices, hosts) or the availability of resources (such as battery, display, network, bandwidth). More specific examples include local weather, ambient light conditions, local pollution or allergy levels, the ISDN number and call number/location of a periodical, date and page number of article in periodical, objects, businesses (of all kinds including entertainment venues) or other geographical points of interest such as cross-streets or landmarks, or nearby activity such as street construction or parade routes.

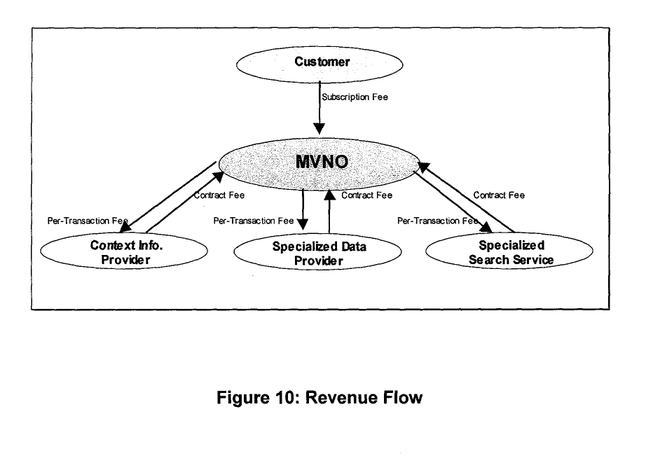

Table 1 also indicates, in conjunction with the diagram of FIG. 10, the revenue flow for the first embodiment of the business model. As discussed above, although many different operators will be involved in the eventual production of information supplied to a customer, the customer will prefer or expect only a single bill. Any transactions between the virtual operator and any service provider should be opaque to the customer. The customer will preferably only see one bill for the supplied information. Preferably this bill will originate from the primary biller, which in general will be the virtual operator.

Of course, alternatively the customer and service provider can contract directly in much the same manner as the customer and the virtual operator. In this case, the customer may either send a particular identifier to the virtual operator along with each request to permit the virtual operator to access the service provider or the identifier may be stored and supplied automatically by the virtual operator whenever necessary to access the service provider.

As shown in Table 1 and illustrated in FIG. 1, the virtual operator preferably receives income from different sources. The virtual operator receives income from the customer, who pays a subscription fee to the virtual operator. This subscription fee is preferably a term contract for all services provided from the virtual operator to the customer over a set period of time. The term contract can be, for example, a month-to-month, year-to-year or multiyear contract. The set period of time may be any mutually agreeable set period of time, for example a month or year. Alternatively, the customer may pay on a per-transaction (search) basis or a combination of a per-transaction/time basis. In the latter case, the customer may pay for basic services from the virtual operator and receive a set number of special requests per month. In this case, after the customer has exceeded his or her monthly limit of requests, each additional request will cost the customer either a set amount or an amount based on the time spent on (complexity of) the search.

Similarly, after becoming the proxy of the customer for a particular search the virtual operator may communicate with at least one of the other service providers, i.e. the Context Information Provider, Specialized Data Provider, Specialized Search Service Provider, and Internet Service Provider. The other service providers may have a term contract with the virtual operator for monthly or yearly access, for instance. Each term contract between the virtual operator and a particular service provider provides compensation to the virtual operator for selecting the services of that service provider over the course of the term. The compensation is a set fee that is transferred from the service provider to the virtual operator once per term or in installments over the duration of the term.

The virtual operator also provides remuneration to the service provider for each transaction between the virtual operator and the service provider. This is to say that each time the virtual operator sends a request (i.e. accesses the service provider) to the service provider and/or the service provides the desired service as well as responses, a service fee is charged by the service provider to the virtual operator. The charge may be per transaction or based on the amount of time/computing resources required for the service provided. The timing of the payments for the service fee is determined by the contract between the virtual operator and the service provider. For example, a monthly bill may be submitted to the virtual operator from the service provider for services provided during the previous month or an account held by the virtual operator may be charged immediately (or soon) after the transaction between the virtual operator and the service provider has been concluded. This payment plan may be modified in any manner specified in the contract, for instance, as described in the limited transaction plan between the customer and the virtual operator above. In addition, the customer may cancel a query at any stage in the process below. However, if the virtual operator has already accessed the service provider, the virtual operator and customer may still be charged respective fees for access to the service.

Benefits of the above financial compensation plans by all parties include: customer satisfaction (due to, in part, the low amount of attention required to maintain the account), retention of the customer by the virtual operator, access to customers by the service providers, and, of course, a revenue stream for the virtual operator and service providers.

In one example of operation, the user requests information about restaurants on his or her cell phone. The request is customized by adding, say, customer preferences of restaurant ethnicity, the time/date and local construction. The virtual operator determines that local restaurants are desired and sends a search to an Internet provider and a Specialized Data Provider. The search responses in a list of restaurants and assorted details regarding those restaurants, which the virtual operator applies the third analysis to, selecting and organizing the restaurants in alphabetical order, ease of transport to the restaurants, or rating using the ethnicity preferences, the opening/closing times (in relation to the current time/date) to present the best choices to the customer, restaurant distance, customer mode of transportation, roadwork, etc . . . The virtual operator then transmits a map to the restaurants including GPS information or a set of selectable lists to the cell phone display or sends out a voice mail with selection capabilities. Note that the service providers return responses and the user/terminal receives results. The results are based on the responses returned by the service providers but may or may not be the same as the responses, dependent on, for example, whether the third analysis modifies the responses.

In another example, the user Speaks “Go to My Yahoo” into his PDA, the user interface translates the request and sends it to a request adapter (which is in the device) which is translated to code such as “GET my.yahoo.com”. The device next performs request personalization and adds its own headers to the request message. The device sends this modified request message to the Personal User Proxy (PUP), which is a function of the virtual operator.

The PUP code may look something like:

GET my.yahoo.com

START Device Specific Header

Device_Params {

device_type=pda

max_resolution=300×200

colors=65535

sound cap=g711, g7231, g729

video cap=mpeg4, h263

}

Location_info {

Address=670 Teatree Ct, San Jose, Calif. 95128

LocAlias=Home

TimeAtLoc=45 min

}

END Device Specific Header

The Personal User Proxy looks at the incoming service request and determines that in the current context (based on location, time, past history, nearby people) the user is usually interested in certain type of content. The PUP has the following message exchange with one of the service providers:

Use Service Negotiation Protocol to negotiate privacy and personalization settings.

GET my.yahoo.com

DEVICE SPECIFIC HEADER

START PUP Header

login_info

Content_Preferences {

cat=Movies, type=text, graphics

cat=Restaurants, type=text, no_graphics

cat=nightlife, type=text

Prioritize=location, rating

}

END PUP Header

At the Service Provider:

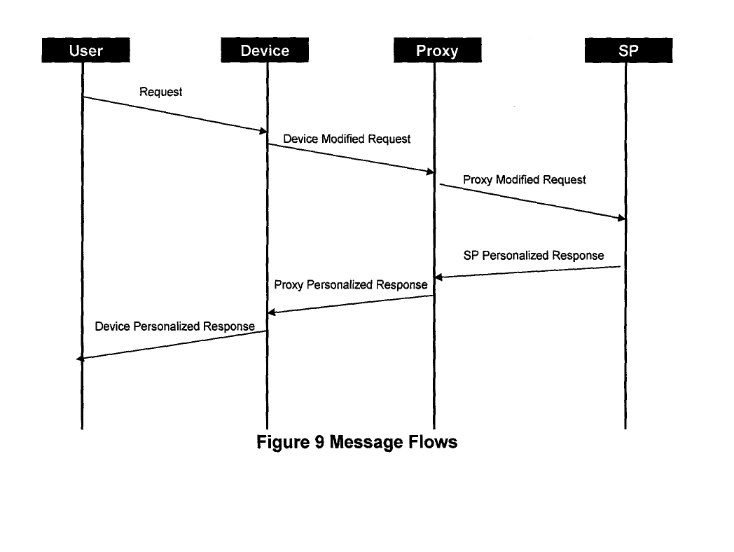

Yahoo gets the already personalized and specific request from the user's Personal User Proxy and passes the request to its service adapter (which is specific to and thus dependent on the particular Service Provider). The service adapter checks the local user profile and finds that the user has already seen 3 of the newest movies, it only selects the ones he hasn't seen as options. The Service Adapter determines that the user didn't like the last restaurant it recommended so it excludes it. The service adapter sees that the user always goes to one specific theatre company (e.g. Century theaters) to see all his or her movies. It uses marketing personalization to offer a deep discount at a rival theatre company that is also nearby. The service provider then sends the personalized content to the mobile user. FIG. 9 shows the message flows between the various entities as the personalization is performed in this example.

The embodiment above is merely one example of context-aware computing, which includes functions beyond those presently available and included in customized or personalized systems. Systems envisioned currently may include some measure of customization at the level of display format, selection of search universe, and/or customer profile. However, such systems do not include methods for controlling the overall result (and responsiveness) of the system according to the real-time condition or situation in which the user is situated.

On the other hand, the context-aware search service above incorporates many features. The context-aware search service may integrate simple profile-based information with advanced context-aware information. In addition, the context-aware search service may use profile and context information to personalize the nature of the inquiry (for example, works of Shakespeare versus where books are located), the context of the inquiry (for example, location of books near the customer's location), and the context of the user/terminal (for example, capabilities of the customer's device, whether the customer is on foot or on a train).

The services and functionality described herein describe some embodiments of a context-aware system upon which a business model may be built. One example of additional services related to this system includes a service to analyze the customer's purchase history and make recommendations to the customer regarding new or other vendors. Another example of an additional service includes a service to aggregate customization information with the goal of creating business proposals to subscribing vendors on behalf of a group of potential buyers. The data may be aggregated in order to eliminate privacy issues, and to discover and present new potential markets to sellers. A third example includes a service to organize, verify, filter, and enhance search information and provide results to specially-formatted queries. This service may be a complementary service to the Specialized Search Service Provider described previously or may be a trusted source of high-quality information in a specialized domain (for example, ISBN data or GPS data augmented with vendor information provided by subscribers to the service).

Such services based on the context aware search services system may provide the customer a significant amount of control over their individual information, considering the potentially invasive perception given by the processing of customer purchase data.

In addition, although the context-aware search is typically provided for customers using mobile communication equipment, users of non-mobile communication equipment may also make use of the system for the same reasons as mobile users. In any case, the customer may cancel a request at any stage and real-time information, such as the time, the position of the customer or the medical condition of the customer, may be continually update the request or analyses used to process the request.

The context-aware search in general surmises something about the state of the customer, e.g. to determine what the customer is doing, from at least all of the relevant customer and context information available to the service and uses this additional information to enhance the efficiency of the search requested by the customer as well as appropriately presenting the results to the customer. Personalization may be performed at any or all of three places in the network: the device, the virtual operator, and/or the Service Provider.

While the invention has been described with reference to specific embodiments, the description is illustrative of the invention and not to be construed as limiting the invention. Various modifications and applications may occur to those skilled in the art without departing from the true spirit and scope of the invention as defined in the appended claims. Accordingly, this description and drawings are to be regarded in an illustrative rather than a restrictive sense.

TABLE 1
Entities Required for CONTEXT AWARE SEARCH SERVICE
Attorney Docket No. 10745/89

| | | VALUE | | |
|---|---|---|---|---|
| | | PROPOSITION | THIS ENTITY | THIS ENTITY |
| ENTITY | DESCRIPTION | TO THIS ENTITY | PAYS | IS PAID BY |
| MVNO | Proxy acting on the behalf of | Customer Retention | CIP (per transaction) | Customer (monthly fee) |
| | customer | Transaction Revenue | SDP (per transaction) | CIP (contract fee) |
| | | | SSS (per transaction) | SDP (contract fee) |
| | | | | SSS (contract fee) |
| Context | Provides real-time context | Access To Customers | MVNO (contract fee) | MVNO (per transaction) |
| Information | information, database information | Transaction Revenue | | |
| Provider (CIP) | and/or any other kind of video, | | | |
| | audio or text information and data | | | |
| Specialized | Provides specialized data, such as | Access To Customers | MVNO (contract fee) | MVNO (per transaction) |
| Data Provider | ISBN or GPS data | Transaction Revenue | | |
| (SDP) | | | | |
| Specialized | Provides specialized and/or | Access To Customers | MVNO (contract fee) | MVNO (per transaction) |
| Search Service | optimized search capability, | Transaction Revenue | | |
| Provider(SSSP) | through high-quality search engine | | | |
| | or high-quality data | | | |

We claim:

1. A context aware search services system, comprising:
a virtual network operator;
a terminal in communication with the virtual network operator, the virtual network operator to customize requests from the terminal using context information; and
at least one service provider in communication with the virtual network operator, the virtual network operator operable to selectively forward the customized requests to the at least one service provider and provide a result based on responses returned by the service provider to the terminal.

2. The context aware search services system of claim 1, wherein the virtual network operator is further in communication with at least one external context provider that provides at least one of an external context of the terminal, context of usage of the terminal, and a user operating the terminal.

3. The context aware search services system of claim 2, wherein the at least one external context provider provides at least one of an identity of the user, a physical location of the user, a method of locomotion of the user, a time of the request from the terminal and a date of the request from the terminal.

4. The context aware search services system of claim 1, wherein the virtual network operator provides information regarding preferences of the user.

5. The context aware search services system of claim 1, wherein the virtual network operator comprises at least one analysis to customize the requests from the terminal prior to submission to the at least one service provider.

6. The context aware search services system of claim 5, wherein the at least one analysis comprise a first analysis that determine an exact nature of the request from the user.

7. The context aware search services system of claim 5, wherein the at least one analysis comprise a first analysis that limit a universe of reference that the at least one service provider examines to provide the responses returned to the virtual network operator.

8. The context aware search services system of claim 6, wherein the at least one analysis further comprise a second analysis that limit a universe of reference of which the at least one service provider examines to provide the responses returned to the virtual network operator.

9. The context aware search services system of claim 1, wherein the virtual network operator comprises at least one analysis to customize the responses from the service provider prior to returning results to the terminal.

10. The context aware search services system of claim 9, wherein the at least one analysis select the most appropriate content and format for presentation by the terminal to the user.

11. The context aware search services system of claim 1, wherein the external context of the terminal is specific to at least one of spatial environs of the user and temporal environs of the request.

12. The context aware search services system of claim 1, wherein an overall result from the virtual network operator to the terminal, and not merely a display on the terminal, is contextualized.

13. The context aware search services system of claim 1, wherein only the virtual network operator contains user preferences that customize the request.

14. The context aware search services system of claim 1, wherein the virtual network operator stores user preferences.

15. The context aware search services system of claim 14, wherein the user preferences are updated upon occurrence of a specific event.

16. The context aware search services system of claim 15, wherein the specific event is each request.

17. The context aware search services system of claim 1, wherein the responses from all service providers of the at least one service provider are received by the virtual network operator prior to the result being supplied to the terminal.

18. The context aware search services system of claim 10, wherein the responses from all service providers of the at least one service provider are received by the virtual network operator and selected by the at least one analysis prior to the result being supplied to the terminal.

19. The context aware search services system of claim 1, wherein the at least one service provider comprises at least one of an Internet provider, a specialized data provider, and a specialized service provider.

20. The context aware search services system of claim 1, wherein the at least one service provider comprises at least two of an Internet provider, a specialized data provider, and a specialized service provider.

21. The context aware search services system of claim 1, wherein the terminal comprises one of a cellular telephone, personal digital assistant, visor, portable computers, and on-board vehicle computer.

22. The context aware search services system of claim 1, wherein the communication between the terminal and the virtual network operator is wireless.

23. The context aware search services system of claim 1, wherein a transaction fee is assessed by the at least one service provider to the virtual network operator for each request provided by the virtual network operator to the at least one service provider.

24. The context aware search services system of claim 1, wherein the result includes analysis of a purchase history of the user and recommendations are transmitted to the terminal regarding potential vendors.

25. The context aware search services system of claim 1, further comprising a specialty system to analyze a purchase history of the user and recommend potential vendors to the user based on the request.

26. The context aware search services system of claim 1, wherein the customization information included in the customized request is aggregated with customization information from other users of other terminals and a business proposal is created and supplied to subscribing vendors on behalf of the user and the other users.

27. The context aware search services system of claim 1, further comprising a specialty system to aggregate customization information included in the customized request with customization information from other users of other terminals and to create and supply a business proposal to subscribing vendors on behalf of the user and the other users.

28. The context aware search services system of claim 1, wherein specially formatted requests are organized, verified, filtered and enhanced and special results are provided to the specially formatted requests.

29. The context aware search services system of claim 1, further comprising a specialty system to organize, verify, filter and enhance specially formatted requests and to provide special results to the specially formatted requests.

30. The context aware search services system of claim 1, wherein the user has control over whether user preferences are supplied to the at least one service provider.

31. The context aware search services system of claim 27, wherein the user has control over whether user preferences are supplied to the specialty system.

32. The context aware search services system of claim 1, wherein the customized request includes one of a real-time condition and a real-time situation in which the user is situated.

33. A network operator that:
accepts a query from a user;
customizes the query by including at least customer-identifying information of the user and context information that contains at least one of an external context of the user and a context of usage of the user; and
returns a result based on the customized query to the user.

34. The network operator of claim 33, wherein the operator one of furnishes the customer-identifying information of the user and is in communication with an entity that furnishes the customer-identifying information of the user, the operator one of furnishes the context information and is in communication with an entity that furnishes the context information, and the operator is in communication with a service provider that searches a data base based on the customized query and returns a response based on the search.

35. The network operator of claim 33, wherein the operator comprises at least three sets of analyses to customize the requests, a first analysis to determine an exact nature of the query from the user, a second analysis to limit a universe of reference to be examined to provide the result, and a third analysis to select the most appropriate content and format for presentation to the user.

36. The network operator of claim 34, wherein the operator comprises at least two sets of analyses to customize the requests, a first analysis to determine an exact nature of the query from the user, a second analysis to limit a universe of reference to be examined to provide the result, and a third analysis to select the most appropriate content and format of the response for presentation to the user.

37. The network operator of claim 33, wherein the operator one of furnishes the customer-identifying information of the user and is in communication with an entity that furnishes the customer-identifying information of the user, the operator one of furnishes the context information and is in communication with an entity that furnishes the context information, and the operator is in communication with a plurality of service providers that each search a different data base based on the customized query and return a response based on the search.

38. The network operator of claim 37, wherein the operator comprises at least two sets of analyses to customize the requests, a first analysis to determine an exact nature of the query from the user, a second analysis to limit a universe of reference to be examined to provide the result, and a third analysis to select the most appropriate content and format of the responses for presentation to the user.

39. The network operator of claim 33, wherein the result includes analysis of a purchase history of the user and recommendations are transmitted to the user regarding potential vendors.

40. The network operator of claim 33, wherein the customization information included in the customized request is aggregated with customization information from other users and a business proposal is created and supplied to subscribing vendors on behalf of the user and the other users.

41. The network operator of claim 33, wherein specially formatted requests are organized, verified, filtered and enhanced and special results are provided to the specially formatted requests.

42. The network operator of claim 33, wherein the customization includes one of a real-time condition and a real-time situation in which the user is situated.

43. A method of customizing a request of a user to a system, the method comprising:
augmenting the request with at least context information that contains at least one of an external context of the user making the request, an external context of one of the user and terminal used to make the request, and characteristics of the terminal used to make the request;
searching at least one database with information dependent on the augmented request; and
returning a result to the user based on responses of the search.

44. The method of claim 43, further comprising further augmenting the request with customer-identifying information of the user prior to searching the database.

45. The method of claim 43, further comprising applying a plurality of sets of analyses to customize the augmented request prior to searching the database and applying at least one analysis to the responses of the search prior to returning the result to the user.

46. The method of claim 43, further comprising determining an exact nature of the request from the user and limiting a universe of the database to be searched prior to searching the database and forming the result by selecting a most appropriate content and format for presentation of the responses prior to returning the result to the user.

47. The method of claim 43, further comprising including analysis of a purchase history of the user in the responses and transmitting recommendations to the user regarding potential vendors.

48. The method of claim 43, further comprising aggregating the customization information of the user with customization information from other users, creating a business proposal, and supplying the business proposal to subscribing vendors on behalf of the user and the other users.

49. The method of claim 43, further comprising organizing, verifying, filtering and enhancing requests to form specially formatted requests and providing special results to the specially formatted requests.

50. The method of claim 43, further comprising including one of a real-time condition and a real-time situation in which the user is situated in the context information.

51. The method of claim 43, further comprising permitting the user to have control over whether at least some customer-identifying information is supplied to an entity that performs the search.

52. A terminal that:
accepts a request from a user;
transmits the request to a network operator where the request is customized by including at least customer-identifying information of the user and context information that contains at least one of an external context of the terminal and a context of usage of the terminal; and
accepts a return from the network operator based on the customized request and presents the return to the user.

53. The terminal of claim 52, wherein the terminal transmits the request to the operator which one of furnishes the customer-identifying information of the user and is in communication with an entity that furnishes the customer-identifying information of the user, one of furnishes the context information and is in communication with an entity that furnishes the context information, and is in communication with a service provider that searches a data base based on the customized request and returns a response based on the search.

54. The terminal of claim 52, wherein the request is subjected to at least two sets of analyses to customize the request, a first analysis to determine an exact nature of the request from the user, a second analysis to limit a universe of reference to be examined to provide the result, and a response based on the request is subjected to a third analysis to select the most appropriate content and format for presentation to the user to transform the response into the return.

55. The terminal of claim 53, wherein the request is subjected to at least two sets of analyses to customize the request, a first analysis to determine an exact nature of the request from the user, a second analysis to limit a universe of reference to be examined to provide the result, and the response is subjected to a third analysis to select the most appropriate content and format for presentation to the user to transform the response into the return.

56. The terminal of claim 52, wherein the terminal transmits the request to the operator which one of furnishes the customer-identifying information of the user and is in communication with an entity that furnishes the customer-identifying information of the user, one of furnishes the context information and is in communication with an entity that furnishes the context information, and is in communication with a plurality of service providers that each search a different data base based on the customized request and return a response based on the search.

57. The terminal of claim 56, wherein the request is subjected to at least two sets of analyses to customize the request, a first analysis to determine an exact nature of the request from the user, a second analysis to limit a universe of reference to be examined to provide the result, and responses are subjected to a third analysis to select the most appropriate content and format for presentation to the user to transform the responses into the return.

58. The terminal of claim 52, wherein the result includes analysis of a purchase history of the user and recommendations are transmitted to the user regarding potential vendors.

59. The terminal of claim 52, wherein the customization information included in the customized request is aggregated with customization information from other users and a business proposal is created and supplied to subscribing vendors on behalf of the user and the other users.

60. The terminal of claim 52, wherein specially formatted requests are organized, verified, filtered and enhanced and special results are provided to the specially formatted requests.

61. The terminal of claim 52, wherein the customization includes one of a real-time condition and a real-time situation in which the user is situated.
